(19) United States
(12) Patent Application Publication
(10) Pub. No.: US 2016/0125137 A1
(43) Pub. Date: May 5, 2016

(54) ELECTRONIC HEALTH RECORD HANGING PROTOCOL AND DISPLAY FOR AN INTEGRATED CLINICAL COURSE

(71) Applicant: Zelina Fluency, Inc., Water Mill, NY (US)

(72) Inventor: Romy Chung OTT, Water Mill, NY (US)

(21) Appl. No.: 14/927,676

(22) Filed: Oct. 30, 2015

Related U.S. Application Data
(60) Provisional application No. 62/073,842, filed on Oct. 31, 2014.

(51) Int. Cl. G06F 19/00; G06F 17/30

(52) U.S. Cl. CPC G06F 19/321; G06F 17/30265

(57) ABSTRACT

The present disclosure describes a system and method for visualizing clinical data. The system can display multiple kinds of clinical data in a timeline format. Further, the system can provide a user with a holistic view of a subject's health.

### CROSS REFERENCE

This application claims the benefit of U.S. Provisional Application No. 62/073,842, filed Oct. 31, 2014, which is incorporated herein by reference in its entirety.

### BACKGROUND

Many healthcare institutions currently employ electronic health record (EHR) systems to collect and store patient data. However, the current EHR systems can be insufficient in guiding a care team to manage a patient proactively. The current EHR systems can provide limited information in an inefficient manner, and can preclude an accurate assessment of a patient's overall state of health. Health care systems improving efficacy and efficiency of medical health records remain unavailable.

### SUMMARY OF THE INVENTION

In some embodiments, the invention provides a method comprising: a) receiving into a memory sector from a first data source a first electronic communication in a computer-readable code, wherein the first electronic communication contains a first time-stamped clinical event of a first subject; b) receiving into the memory sector from a second data source a second electronic communication in a computer-readable code, wherein the second electronic communication contains a second time-stamped clinical event of the first subject; c) reading by a computer processor the computer-readable code from the first electronic communication to identify the first time-stamped clinical event of the first subject; d) reading by the computer processor the computer-readable code from the second electronic communication to identify the second time-stamped clinical event of the first subject; e) generating by an image processor a first image based on the identity of the first time-stamped clinical event of the first subject; f) generating by the image processor a second image based on the identity of the second time-stamped clinical event of the first subject; and g) displaying on a visual display the first image and the second image, wherein the visual display organizes the first image and the second image in a first dimension based on medical service type and in a second dimension based on time stamp.

In some embodiments, the invention provides a computer program product comprising a computer-readable medium having computer-executable code encoded therein, the computer-executable code adapted to be executed to implement a method comprising: a) providing a healthcare management system, wherein the healthcare management system comprises: i) a data receiving module; ii) an identification module; iii) an image generation module; and iv) an output module; b) receiving by the data receiving module a first electronic communication in a computer-readable code, wherein the first electronic communication contains a first time-stamped clinical event for a subject from a first data source; c) receiving by the data receiving module a second electronic communication in a computer-readable code, wherein the second electronic communication contains a second time-stamped clinical event for the subject from a second data source; d) identifying by the identification module the first time-stamped clinical event of the subject by reading the computer-readable code of the first electronic communication; e) identifying by the identification module the second time-stamped clinical event of the subject by reading the computer-readable code of the second electronic communication; f) generating by the image processing module a first image based on the identity of the first time-stamped clinical event of the subject; g) generating by the image processing module a second image based on the identity of the second time-stamped clinical event of the subject; and h) outputting by the output module a visual display of the first image and the second image, wherein the output module organizes the visual display so that the first image and the second image are displayed in a first dimension based on medical service type and in a second dimension based on time stamp.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE FIGURES

FIG. 1 depicts an example landing page for a display of the invention.

FIG. 2 depicts an example display of the invention with expanded urology sections.

FIG. 3 depicts an example display of the invention with expanded neurology sections.

FIG. 4 is a continuation of the display of FIG. 3.

FIG. 5 displays a full expansion of three organ systems for a patient.

FIG. 6 is a continuation of the display of FIG. 5.

FIG. 7 displays an expanded treatment section of a system of the invention.

FIG. 8 depicts an example treatment calculation performed by a system of the invention.

FIG. 9 illustrates a computer system for facilitating methods, systems, kits, or devices of the disclosure.

FIG. 10 illustrates a global network that can transmit a product of the invention.

### DETAILED DESCRIPTION

### System of the Invention.

Healthcare institutions can use electronic medical records (EMRs), or digital health records, to track a patient's health history at a particular institution. Electronic health records (EHRs) are computerized systems that allow a patient's medical information to be shared across multiple healthcare institutions. EHRs can provide patient data over time, for example, to monitor the patient's health and to identify patients due for preventive screenings and doctor visits.

Patient data can be compiled in various formats including, for example, numerical values, laboratory reports, photographs, physician notes, radiological images, and histopathological images. Current EHR systems can categorize patient data based on the type of data available, and can allow a user to access only one type of data at a time. A user can also see a specific data type over time; for example, a doctor would be able to see a change in laboratory values of a patient over the course of days, months, or years.

Described herein are methods and systems providing a visual representation of clinical data and an integrated clinical course (ICC) for a subject. The present invention can integrate multiple types of data from various data sources to provide a single display of clinically-relevant data. The system can gather data from, for example, EHRs, EMRs, personal health records (PHR), admitting-discharge-transfer (ADT) reports, laboratory reports, pharmacy medical reports (PMR), Healthcare Information Exchange (HIE) data, insurance claims reports, medical claims, patient monitoring devices, and other sources of clinical data.

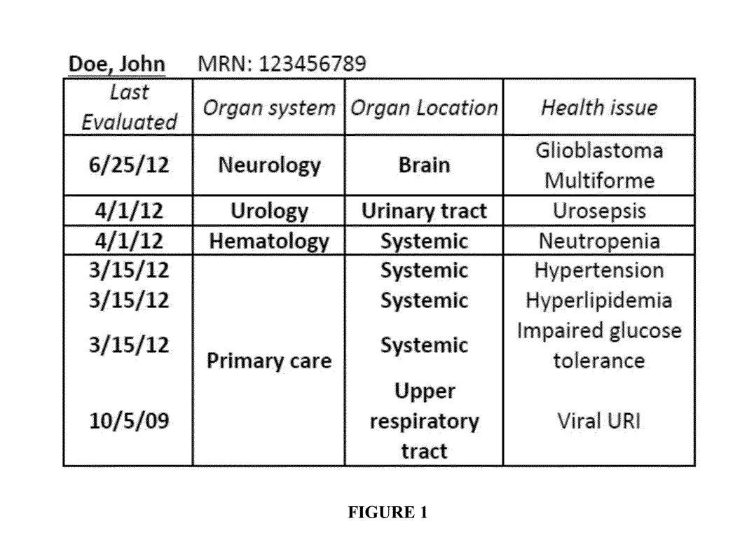

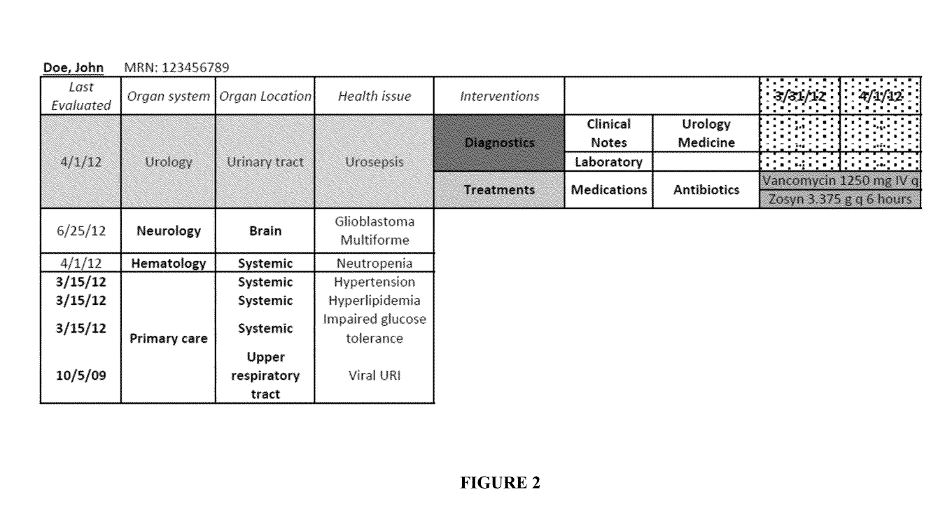

A system of the invention can provide a chronological, visual display of a subject's health history, which can be denoted as the subject's integrated clinical course (ICC). The invention can provide a visual timeline showing, for example, clinical results, diagnoses, symptoms, subject complaints, treatments, inpatient stays, outpatient stays, and user notes, to display the clinical status of one or more health conditions of the subject. Users of the present invention can quickly and accurately assess various forms of clinical data to aid in decision-making, and view connections between diagnostic information and treatment information. An illustrative example of the invention is shown in FIGS. 1-2. The categories of data displayed in the invention can be collapsed or expanded based on a user's preference. If no data are available for a specific section of the display, then that area can be grayed out and unexpandable. Clicking on an area of the ICC can cause a new window to pop up. The invention can display multiple health issues for a subject.

The present invention can display several types of subject data in single visual presentation. The visual presentation can display multiple timelines of data to provide a holistic picture of a subject's overall state of health. For example, the x-axis of a display of the invention can signify time, and the y-axis can be organized by, for example, specialties, sub-specialties, organ systems, health issues, diagnostics, or treatment. For example, a first dimension of the display can be organized by a medical service type and associated clinical events, and a second dimension of the display can be organized based on a time stamp of the medical service type or clinical event.

A system of the invention can provide visualization for inpatient and outpatient stays. Inpatient data can be compressed along the x-axis and be represented by a single discharge pop-up. A user can then select the discharge pop-up to receive more data regarding the inpatient stay of the patient.

Non-limiting examples of specialties and subspecialties that can be displayed in a system of the invention include allergy, andrology, anesthesia, angiology, cardiology, dentistry, dermatology, emergency, endocrinology, family, gastroenterology, geriatrics, gerontology, gynecology, hematology, hepatology, immunology, infectious diseases, intensive care, nephrology, neurology, neurosurgery, obstetrics, oncology, ophthalmology, oral and maxillofacial surgical, orthopedics, otolaryngology, paleopathology, palliation, pathology, pediatrics, podiatry, psychiatry, pulmonology, radiology, rehabilitation, rheumatology, serology, sexual health, sports, surgery, toxicology, transplantation, and urology.

Non-limiting examples of health issues that can be displayed in a system of the invention include acquired immunodeficiency syndrome (AIDS), alcoholism, Alzheimer's disease, amyotrophic lateral sclerosis, arthritis, asthma, atherosclerosis, atrial fibrillation, attention deficit hyperactivity disorder, back pain, beta-thalassemia, bipolar disorder, bone fracture, bronchitis, bursitis, cancer, cardiac arrhythmia, celiac disease, cellulitis, cerebral palsy, chest pain, chronic heart failure (CHF), chronic infection, chronic obstructive pulmonary disease (COPD), cirrhosis, congestive heart failure, coronary artery disease, Crohn's disease, cystic fibrosis, deep venous thrombosis, dehydration, dementia, depression, diabetes, digestive malignancy, diverticulitis, Down's syndrome, drug addiction, eczema, endometriosis, epilepsy, esophagitis, failure to thrive of senescence, fibromyalgia, gastroenteritis, gastrointestinal hemorrhage, gastrointestinal obstruction, glaucoma, glioblastoma multiforme, gout, heart failure, hepatitis, hernia, human immunodeficiency virus (HIV), hypertension, hyperthyroidism, hypothyroidism, infertility, joint dislocation, kidney infection, lupus, lyme disease, lymphoma, malaria, malignant disease, multiple sclerosis, muscle sprain, myocardial infarction (MI), myositis, narcolepsy, neoplasm, obesity, osteomyelitis, osteoporosis, Parkinson's disease, peptic ulcer, polycystic ovary syndrome, pneumonia, psoriasis, pulmonary embolism, renal failure, respiratory failure, rheumatoid arthritis, schizophrenia, seizure, sleep apnea, specific end-stage disease states, stroke, peripheral vascular disorders, sepsis, sickle cell anemia, Sjören's syndrome, syncope, Tay-Sachs disease, tendonitis, tuberculosis, ulcerative colitis, urinary tract infection, urosepsis, uveitis, valvular heart disease, vertigo, viral illness, and vitiligo.

Non-limiting examples of cancers that can be displayed in a system of the invention include acute lymphoblastic leukemia, acute myeloid leukemia, adrenocortical carcinoma, AIDS-related cancers, AIDS-related lymphoma, anal cancer, appendix cancer, astrocytomas, basal cell carcinoma, bile duct cancer, bladder cancer, bone cancers, brain tumors, such as cerebellar astrocytoma, cerebral astrocytoma/malignant glioma, ependymoma, medulloblastoma, supratentorial primitive neuroectodermal tumors, visual pathway and hypothalamic glioma, breast cancer, bronchial adenomas, Burkitt lymphoma, carcinoma of unknown primary origin, central nervous system lymphoma, cerebellar astrocytoma, cervical cancer, childhood cancers, chronic lymphocytic leukemia, chronic myelogenous leukemia, chronic myeloproliferative disorders, colon cancer, cutaneous T-cell lymphoma, desmoplastic small round cell tumor, endometrial cancer, ependymoma, esophageal cancer, Ewing's sarcoma, germ cell tumors, gallbladder cancer, gastric cancer, gastrointestinal carcinoid tumor, gastrointestinal stromal tumor, gliomas, hairy cell leukemia, head and neck cancer, heart cancer, hepatocellular (liver) cancer, Hodgkin lymphoma, Hypopharyngeal cancer, intraocular melanoma, islet cell carcinoma, Kaposi sarcoma, kidney cancer, laryngeal cancer, lip and oral cavity cancer, liposarcoma, liver cancer, lung cancers, such as non-small cell and small cell lung cancer, lymphomas, leukemias, macroglobulinemia, malignant fibrous histiocytoma of bone/osteosarcoma, medulloblastoma, melanomas, mesothelioma, metastatic squamous neck cancer with occult primary, mouth cancer, multiple endocrine neoplasia syndrome, myelodysplastic syndromes, myeloid leukemia, nasal cavity and paranasal sinus cancer, nasopharyngeal carcinoma, neuroblastoma, non-Hodgkin lymphoma, non-small cell lung cancer, oral cancer, oropharyngeal cancer, osteosarcoma/malignant fibrous histiocytoma of bone, ovarian cancer, ovarian epithelial cancer, ovarian germ cell tumor, pancreatic cancer, pancreatic cancer islet cell, paranasal sinus and nasal cavity cancer, parathyroid cancer, penile cancer, pharyngeal cancer, pheochromocytoma, pineal astrocytoma, pineal germinoma, pituitary adenoma, pleuropulmonary blastoma, plasma cell neoplasia, primary central nervous system lymphoma, prostate cancer, rectal cancer, renal cell carcinoma, renal pelvis and ureter transitional cell cancer, retinoblastoma, rhabdomyo sarcoma, salivary gland cancer, sarcomas, skin cancers, Merkel cell skin carcinoma, small intestine cancer, soft tissue sarcoma, squamous cell carcinoma, stomach cancer, T-cell lymphoma, throat cancer, thymoma, thymic carcinoma, thyroid cancer, trophoblastic tumor (gestational), cancers of unknown primary site, urethral cancer, uterine sarcoma, vaginal cancer, vulvar cancer, Waldenström macroglobulinemia, and Wilms tumor.

Non-limiting examples of subcategories under the diagnostics group of a system of the invention include vital signs, laboratory data, clinical notes, medical imaging, radiological imaging, histopathology, and genetics. The clinical notes can include symptomatic data or observations provided by the subject. The clinical notes can further include notes from a user including, for example, notes regarding a user's assessment, plan of treatment, and physical exam results.

The vital signs that can be displayed by a system of the invention include, for example, blood glucose level, blood pressure, body mass index, height, pain, pulse, respiratory rate, temperature, and weight.

The laboratory data that can be displayed by a system of the invention include, for example, absolute neutrophil count (ANC), activated partial thromboplastin time, alanine transaminase levels, albumin levels, alkaline phosphatase levels, amniocentesis results, amylase levels, antinuclear antibody levels, antiphospholipid antibody levels, aspartate transaminase levels, basic metabolic panel results, B-type natriuretic peptide (BNP) levels, bacterial presence, basophil granulocyte levels, bicarbonate levels, bilirubin levels, bleeding time, blood pH, blood type, blood urea nitrogen levels, C-reactive protein levels, calcium levels, cardiac stress test results, catecholamine levels, coagulation factors levels, cholesterol levels, chloride levels, complete blood count, creatinine levels, D-dimer levels, dopamine levels, drug test results, electrocardiograph (EKG), eosinophil granulocyte levels, estradiol levels, fecal occult blood test (FOBT) results, fibrinogen levels, folic acid levels, free cortisol levels, gamma-glutamyl transpeptidase levels, globulin levels, glomerular filtration rate (GFR), glucose levels, hematocrit levels, hemoglobin levels, HIV antibody levels, human chorionic gonadotropin levels, insulin levels, international normalized ratio (INR), iron levels, ketone body levels, lead levels, leukocyte differential count, liver function results, lumbar puncture results, lymphocyte levels, magnesium levels, mean corpuscular volume, mean corpuscular hemoglobin mean corpuscular hemoglobin concentration, myoglobin levels, nitrite levels, monocyte levels, mean platelet volume, neutrophil granulocyte levels, partial thromboplastin time, Pap smear results, phenylalanine levels, phosphate levels, platelet count, potassium levels, progesterone levels, prostate-specific antigen levels, prothrombin time, red blood cell count, sodium levels, testosterone levels, total iron-binding capacity (TIBC), total protein levels, throat culture results, thrombin clotting time, thyroid stimulating hormone levels, thyroxine (T4) levels, toxicity results, transferrin levels, troponin levels, red blood cell distribution width, urinalysis results, urine pH, urobilinogen levels, or white blood cell count. The laboratory results can be displayed in terms of amount, concentration, time, qualitative descriptions, or any combinations thereof.

A system of the invention can display medical and radiological images. The images can be expanded from a thumbnail image size to a larger size based on a user's preference. The medical and radiological images that can be displayed by a system of the invention include, for example, magnetic resonance imaging (MRI) scans, computed tomography (CT) scans, positron emission tomography (PET) scans, X-rays, nuclear medicine imaging, ultrasound, mammography, angiography, arteriography, venogram, spectroscopy, fluoroscopy, or photographs.

The histopathology data that can be displayed by a system of the invention can be from, for example, an autopsy sample, a biopsy sample, or a surgery sample. The analyzed tissue for the histopathology sample can be stained with, for example, hematoxylin, eosin, safranin, oil red O, congo red, silver salts, or antibodies.

The genetic data that can be displayed by a system of the invention include, for example, karyotyping results, genotyping results, epigenetic results, chromosomal abnormalities, aneuploidy, genetic markers, genetic mutations, DNA methylation, phenylalanine hydroxylase mutation, BRCA1/BRCA2 mutations, alpha-1 antitrypsin deficiency, apolipoprotein E mutations, the probability of possessing a gene, the probability of possessing a genotype, an allele, the probability of possessing an allele, the probability of possessing a mutation, a polymorphism, the probability of possessing a polymorphism, restriction fragment length polymorphism (RFLP) test results, polymerase chain reaction (PCR) test results, paternity test results, a nucleic acid sequence, the probability of possessing a nucleic acid sequence, the expression, penetrance, prevalence, copy number, pathway, function, or chromosomal location of any of the foregoing, and combinations thereof.

Non-limiting examples of treatments that can be displayed by a system of the invention include biologic treatments, chemotherapy, radiation oncology, medications, steroid treatments, surgery, interventions, therapy, nutritional regimens, dietary regimens, and self-monitoring regimens.

The types of therapy and interventions that can be displayed by a system of the invention include, for example, acupuncture, amniocentesis, amputation, anesthesia, angioplasty, apheresis, appendectomy, blood transfusion, bowel disimpaction, cardiac defibrillator implant, cardiac pacemaker implant, chemotherapy, colonoscopy, conization, coronary bypass, endoscopy, fluid replacement therapy, gastric bypass, gene therapy, hemodialysis, hormone replacement therapy, hyperbaric oxygen therapy, hysterectomy, immunization, immunotherapy, joint replacement, laser eye surgery, major bladder procedures, kidney and ureter procedures for neoplasm, laparoscopy, liposuction, major joint replacement, mastectomy, massage therapy, organ transplant, physical exam, physical therapy, plasmapheresis, psychotherapy, reattachment of lower extremity, shock therapy, skin graft, spinal fusion wound debridement, stem cell transplant, stent placement, subcutaneous tissue and breast procedures, surgery, tonsillectomy, tracheal intubation, transurethral procedures, tubal ligation, vaccination, or vasectomy.

Non-limiting examples of regimens that a subject undertakes that can be displayed by a system of the invention include self-monitoring, occupational therapy, speech therapy, social service, home health aide, hospice, exercise, wound care, medication management, complication prevention, diet, weight management, fluid management, exacerbation prevention, oxygen therapy, health education, breathing techniques, diabetic counseling, pain management, and infusion with one or more of antibiotics, hydration, steroids, saline, or nutrition.

Non-limiting examples of nutritional or dietary regimens that can be displayed by a system of the invention include normal diet, low-salt diet, low sugar/diabetic diet, low fat/low cholesterol diet, renal (low protein/low potassium) diet, high protein/high calorie diet, low carbohydrate/calorie restricted diet, liquid diet, fluid restricted diet, ground food diet, soft pureed food diet, thickened liquid diet, and clear liquid diet.

Non-limiting examples of medications used for therapy that can be displayed by a system of the invention include 5-fluorouracil, acetaminophen, acetylcysteine, aflibercept, albuterol, alprazolam, anti-depressants, asprin, augmentin, azithromycin, benzodiazepines, bevacizumab, bleomycin, caffeine, carvedilol, ceftriaxone, chloroquine, clonazepam, corticosteroids, coumadin, cyclophosphamide, Decadron™, dexamethasone, diazepam, digoxin, docetaxel, dopamine, doxorubicin, enalapril, enoxaparin, ethinyl estradiol, furosemide, gabapentin, gemcitabine, guaifenesin, heparin, hydralazine, hydrochlorothiazide, ibuprofen, insulin, ipratropium, isosorbide mononitrate, kanamycin, leukotriene inhibitors, levofloxacin, lidocaine, lisinopril, lithium, losortan, lovastatin, lovenox, methotrexate, methylprednisolone, metoprolol, monoamine oxidase inhibitors, moxifloxacin, mustine, nalmefene, naltrexone, naproxen, nebulizers, nitroglycerin, nonsteroidal anti-inflammatory drugs (NSAIDs), normal saline, omeprazole, opioids, penicillin, phenergan with codeine, piperacillin, prednisone, procarbazine, progesterone, proton pump inhibitors, ranibizumab, reserpine, selective serotonic reuptake inhibitors (SSRIs), sertraline, simvastatin, sodium oxybate, somatropin, sorafenib, spironolactone, tamoxifen, taxol, tazobactam, Temodar™, temozolomide, tiotropium, torsemide, triclosan, valsortan, vasopressin, vinblastine, vaccines, valproic acid, vancomycin, vincristine, vancomycin, warfarin, zaroxolyn, and zithromaxm. The medication therapies can be displayed in terms of dosage courses that the subject is prescribed by a healthcare provider.

Non-limiting examples of clinical events that can be displayed by a system of the invention include hospitalizations, discharges, admissions, and transfers. Non-limiting examples of clinical events can include scheduling of appointments, follow-up appointments, rescheduling of appointments, a check-up appointment, a referral, a physical, an immunization, a vaccination, hospital admission, hospital discharge, emergency room admission, emergency room discharge, prescription generation, improvement in a patient's condition, worsening of a patient's condition, administration of medications, blood test, cholesterol test, thyroid hormone levels test, vital signs monitoring, surgery, pregnancy, miscarriage, allergic reaction, drug overdose, and injury. The clinical events displayed by a system of the invention can be time-stamped to indicate when the event occurred in the subject's medical history.

### Users of a System of the Invention.

A user of a system of the invention can be, for example, a patient, a doctor, a nurse, a nurse practitioner, a paramedic, a pharmacist, a physician, a consulting physician, a primary care physician, a social worker, a subspecialty physician, a healthcare provider, a hospital, a hospital administrator, a hospital contractor, a clinician, an attendant, an insurance company, a governmental body, a government agency, a researcher, a nursing home, school, a community health organization, a military institution, a correctional institution, a physician's assistant, or a therapist.

A user of the system can access the invention from, for example, a computer system. The user can then access a subject's clinical information from, for example, the EMR of the subject. The databases that a system of the invention can use can be organized by, for example, age of a subject, gender of a subject, condition of a subject, gravity of the condition of a subject, diseases, interventions, healthcare institutions, or care managers.

Different users of the invention can have different functionality within the display of the invention. For example, any user can be allowed to access only the initial user interface with a login identity. A systems administrator can be given access to all the functions and pages within the invention, and access to administrative functions, which can be locked for all other users.

A primary care physician, subspecialty physician, and consulting physician can be allowed to access, for example, the subject's ICC, subject's data search functions, data mining functions, and note-writing functions. A primary care physician can also modify the appearance of the display of the invention. A nurse can be given access to, for example, the subject's ICC and the subject's data search functions. A nurse can also modify the appearance of the display of the ICC.

A subject can be, for example, an elderly adult, an adult, an adolescent, a child, a toddler, an infant, or a neonate. A subject can be a patient.

The invention can be customized to suit the needs of a particular user. For example, data relating to only a certain specialty can be displayed based on the specialist reviewing the data. Additionally, a user can adjust the displayed data based on the user's preference and needs. The user can add or remove categories of data. The invention can further be customized to the user to display only certain timeframes of data.

Upon logging into a system of the invention, a user can see a landing page, which can contain a single search field. The search field can be used, for example, to search for a specific subject's ICC. A subject can be searched, for example, by the subject's first name, last name, medical record number (MRN), date of birth, inpatient location, or any combination thereof. The searches by name can be performed by any combination of first or last name. The search results can be sorted by, for example, the last time the subject was evaluated, MRN, last name, first name, date of birth, or current inpatient location.

After a user logs onto the system, the system can record the changes that the user makes to the display of the system. The changes can be recorded as a preset protocol that can automatically be activated each time the user logs onto the system.

Once a user has accessed a subject's ICC, a user can see four entities: column 1, denoted as last evaluated; column 2, denoted as organ systems; column 3, organ location; and column 4, disease entities, or health issue. An organ system that is not actively involved in a subject's health indication will not be present, but the user has the option of having the organ system present and grayed out at the bottom of the display. A primary care physician, upon logging into the system, can see all organ systems, with the active organ systems displayed at the top and sorted by the last evaluation date. A subspecialty physician can see the organ systems corresponding to the physician's specialty, which can appear at the top and be automatically expanded.

A system of the invention can underscore the clinical data that has already been reviewed by a user to avoid duplicate review of data. Additionally, a system of the invention can highlight certain areas of the display to indicate that a user has already reviewed this data. Inversely, a system of the invention can indicate which areas of the display have not been reviewed by leaving those areas unmarked.

### Sources of Data.

The present invention can use various sources of patient data to provide a visual representation of the data. The present invention can use clinical databases as sources of patient data. For example, the invention can use EHRs, EMRs, PMRs, PHRs, ADTs, HIE data, and laboratory reports as a source of data. EHRs can be used within healthcare institutions, for example, doctor's offices, hospitals, and clinics, for the purpose of storing, maintaining, and updating subject information. An EHR can contain data from a subject's EMR. EMRs can comprise clinical information, for example, medical history, medications, allergies, immunization status, laboratory test results, radiology images, vital signs, age, weight, height, blood pressure, lifestyle, genomic data, injuries, discharge notes, admission notes, demographic data, and billing information. EHRs can also comprise data from a subject's PHR. A PHR can be a record where the subject maintains clinical data related to a subject's care.

Pharmacy medical records (PMRs) can relate to records regarding a subject's pharmacological history. The PMR can comprise pharmacological history data for a subject, for example, current prescriptions, past prescriptions, drug allergies, drug interactions, side effects, duration of prescription treatment, age, weight, blood pressure, and insurance information.

Admitting-discharge-transfer (ADT) reports can record data regarding a subject's stay at a hospital. The ADT report can comprise data pertaining to, for example, admission to a hospital, discharge from a hospital, transfer between hospitals, and transfer between care providers.

A healthcare information exchange (HIE) can allow hospitals, healthcare institutions, and care providers to easily and efficiently share clinical data about a subject. The clinical data in a HIE can comprise data regarding, for example, the subject's past illnesses, present illnesses, past medications, present medications, allergies, immunization history, injuries, and laboratory test results.

Insurance claim data can provide information regarding, for example, diagnoses made to the subject, procedures that the subject underwent, and drugs that the subject was prescribed.

A system of the invention can also contain health data from patient monitoring devices. The use of patient monitoring devices can allow for real-time remote collection of data to be input into the system. Additionally, the subject can enter data from the monitoring device through, for example, a computer or mobile application of the system. Patient monitoring devices can include, for example, a holter monitor, a pacemaker, an implantable cardioverter defibrillator, a cardiac resynchronization therapy device, a personal emergency response system, a motion sensor, a position sensor, a scale, a blood pressure monitor, a pulse oximeter, and a glucose meter.

A system of the invention can be used along with medical devices and instruments to obtain clinical data about a subject. Non-limiting examples of medical devices and instruments include glucose meters, pulse oximeter, weight scales, blood pressure cuffs, catheters, defibrillators, dialysis machines, electrocardiographic (EKG) devices, heart-lung machines, stethoscopes, two-way audio/video devices, implants, inclinometers, insulin pump, motion detectors, personal emergency response units, prostheses, bed sensors, activities of daily life (ADL) monitors, biometric skin sensors, ophthalmoscopes, otoscopes, ultrasound/echocardiogram devices, impedance monitors, pacemaker, ventilators, and temperature-reading devices.

The present invention can also display non-clinical data related to the subject. The non-clinical data can be provided by, for example, interviews conducted by care managers with the subject and by questionnaires completed by the subject. The non-clinical data can comprise data related to behavior, socioeconomic status, family life, lifestyle, and literacy.

The output of a system of the present invention can be displayed, for example, as a webpage, web-based application, a module, a dashboard, or a graphical interface. The system can be a software application that can be installed on, for example, a computer, a cell phone, a laptop, or a tablet.

### Applications of a System of the Invention.

A system of the present invention can be used to monitor changes in a subject's condition by accessing clinical data for a subject. A user can then determine whether changes to a subject's care protocol need to be made based on a change in the symptoms of a subject. Modifications and additions to the treatment regimens can include, for example, changes in dosing of a therapeutic agent, prescribing of a therapeutic agent, surgery, and enrollment in a support group. A system of the present invention can monitor changes in a subject's therapeutic regimen, for example, a change in a medication prescribed to a subject. The system can monitor a subject's therapeutic regimen over a period of time and determine if and when the regimen changes.

The clinical information that is received by the system can comprise clinical information from EMRs maintained by the healthcare organization or outside of the healthcare organization. The non-clinical information received by the system can arise from an individual patient or a case worker at the healthcare organization inputting non-clinical information into the unified patient record for that patient. The non-clinical information can include, for example, availability of transportation, living arrangements, family relationships, and support networks.

The patient reports that can be generated by the system can be provided to an individual case worker or a care team at the healthcare organization assigned to the individual patient. The patient report can include, for example, the scheduling of medications, dosages of medications, scheduling of follow-up appointments, scheduling follow-up diagnostics, and arranging for outpatient caregivers.

The system can also receive clinical information from individual patients and add that information into the unified patient record for the patient. The clinical information received from the patient can be from one or more sensors worn by or implanted in the patient. The clinical information received by the patient can also be received by a monitor used by the patient. The monitor can be located remotely, and the monitor or the patient can transmit the information to the unified patient record. The monitor can also be located at a healthcare organization.

A system of the invention can generate patient reports via a system comprising a processor programmed or in communication with, for example, access to externally-maintained patient clinical records, a method for inputting non-clinical patient information and a method for maintaining a unified patient record for a population of patients, which are at least partially specific to a particular healthcare organization, wherein the processor generates a patient care report for an individual patient based on the clinical and non-clinical information in the unified patient record for that patient.

A system of the invention can generate a visual representation of a subject's clinical data by obtaining real-time access to the various data sources containing clinical data. A user of the system can see a subject's data in real-time, and the visual display can be automatically updated based on data input to the sources of data used by the invention. Thus, a system of the invention can not only display the historical data of a patient, but also data that is obtained during, for example, a treatment, a medical intervention, or a doctor's visit. The information obtained in real time can be obtained, for example, from data entry, readings of a medical instrument, readings of a biometric device, photographs, scans, and images.

In some embodiments, the system comprises a computer system having a display device, a processor device, a database, a node, a subnode, a memory sector, and media having computer-executable instructions configured to display health data of a subject according to a method described herein. The processor device can comprise an image processor. The system can comprise, for example, computer-readable media, physical memory, physical drives, visual display modules, icon modules, icons, images, memory sectors, and data files.

The system can receive electronic communication comprising, for example, health information, encoded in a computer readable form. The system can extract from the computer-readable code the encoded information. The system can transfer the extracted information to, for example, memory sectors, physical memory, nodes, and subnodes.

A system can comprise a communications interface operatively coupled to a user terminal and a clinical database terminal. The communications interface can be adapted to collect information from the user terminal, the clinical database terminal, or a combination thereof. The information collected can comprise, for example, information related to the health condition of the user, information about a medication administered to the user, and information about a physical condition of the user. The system can further comprise a data storage medium operatively coupled to the communications interface, and adapted to store the user information. The data storage medium can be coupled to a computer processor.

A system of the invention can collect and store an image of the subject's clinical data. The images can be, for example, a pictorial representation of a subject's clinical data or text relating to a subject's clinical data. The system can be configured to assign specific icons, for example, to a health condition or health episode.

A system of the invention can be used to perform intervention or treatment calculations. The calculations can be used to determine how much time has elapsed between, for example, medical interventions, clinical events, medication administration, imaging events, laboratory analyses, or a medical intervention and a treatment outcome. The system can also measure the time between the beginning and end of a therapeutic regimen, for example, the onset of medication and the termination of the medication. The time can be measured in, for example, seconds, minutes, hours, days, weeks, months, or years.

A system of the invention can be used to study a population of subjects who have received the same intervention, for example, a drug. This subpopulation of subjects can then be used to create a chronological display showing the start and stop times of the intervention and the outcomes of the intervention for each subject. A system of the invention can then determine a correlation between length of the intervention or start/stop times of the intervention and health outcomes of the subjects. A system of the invention can combine multiple timelines of interventions to determine the efficacy of combinations of interventions for a population of subjects receiving the multiple interventions. The invention can then determine which combination of interventions was most efficacious, and determine how the interventions should align chronologically to provide an improved therapeutic outcome.

Any tool, interface, engine, application, program, service, command, or other executable item can be provided as a module encoded on a computer-readable medium in computer executable code. In some embodiments, the invention provides a computer-readable medium encoded therein computer-executable code that encodes a method for performing any action described herein, wherein the method comprises providing a system comprising any number of modules described herein, each module performing any function described herein to provide a result, such as an output, to a user.

### EXAMPLES

### Example 1

### Display of a Patient with Glioblastoma Multiforme (GBM)

FIG. 1 depicts an example landing page of patient John Doe's integrated clinical course (ICC) displayed to a primary care user. John Doe has a medical record number (MRN) of 123456789. The landing page is divided by evaluation date, organ system, organ location, and health issue. The oldest event displayed in the patient's history is a primary care evaluation that takes place on Oct. 5, 2009, indicating that the upper respiratory tract is analyzed. The patient is found to have a viral upper respiratory infection (URI). On Mar. 15, 2012, a systemic evaluation of the patient is performed. The patient is found to have hypertension, hyperlipidemia, and impaired glucose tolerance. On Apr. 1, 2012, a systemic hematology evaluation finds that the patient has neutropenia, and a urinary tract evaluation finds that the patient has urosepsis. On Jun. 25, 2012, a neurologic evaluation of the brain finds that the patient has GBM. Each section of the display can be expanded or contracted based on the preference of the user.

FIG. 2 depicts an example landing page of the same patient as above when accessed by a specialist. In this case, the ICC of the patient is accessed by a urologist. FIG. 2 shows that only the information under the organ system denoted “urology” is expanded to include information about interventions that the patient receives. The interventions are divided into diagnostics and treatments. The diagnostics section is subdivided into clinical notes and laboratory data, which is further divided into a urology medicine section. The treatments section is divided into a medications section, which is further divided into an antibiotics section. On Mar. 11, 2012 and Apr. 1, 2012, the patient is intravenously administered 1250 mg of vancomycin and 3.375 grams of Zosyn™ every six hours.

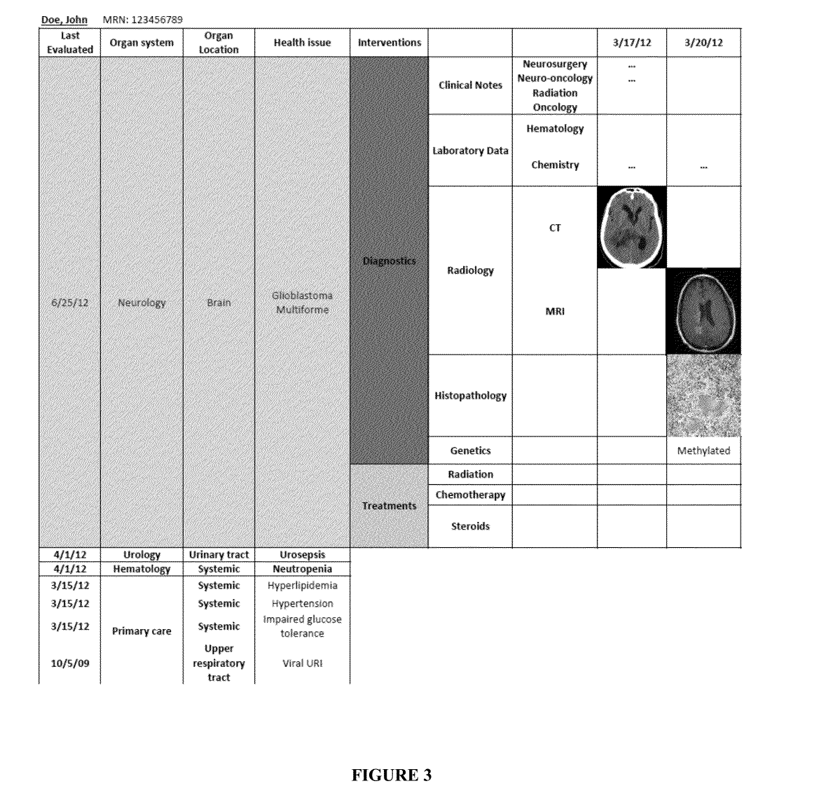

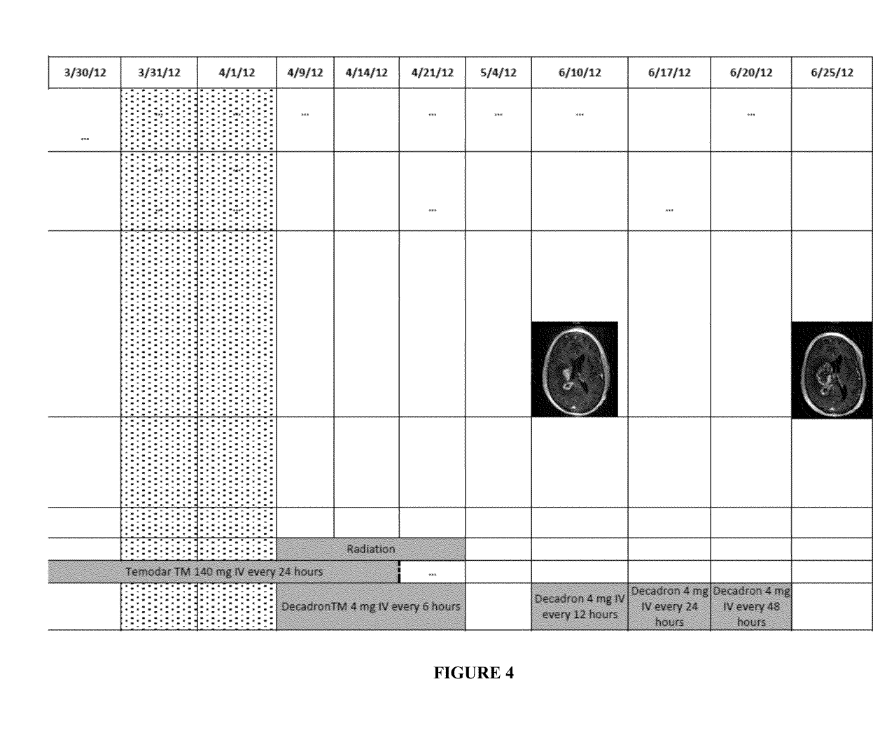

FIGS. 3 and 4 depict a display accessed by a neurologist where only the neurologically-relevant sections of the patient's medical history are expanded. The radiological and pathological images can be clicked to access the accompanying reports. FIG. 3 indicates that the patient is last evaluated on Jun. 25, 2012. The y-axis of both figures is divided by organ system, health issue, diagnostics, and treatment. The organ system selected is neurology, the organ location selected is the brain, and the health issue selected is GBM. FIG. 3 displays clinical data from Mar. 17, 2012 to Mar. 31, 2012 for the patient. FIG. 4 displays clinical data from Apr. 1, 2012 to Jun. 25, 2012 for the patient. The diagnostics section is divided into clinical notes, laboratory data, radiology, histopathology, and genetics. The treatments section is divided into radiation oncology, chemotherapy, and steroids. The clinical notes section is divided into neurosurgery, neuro-oncology, and radiation oncology (FIG. 3). The laboratory data is divided into hematology and chemistry (FIG. 3). The radiology section is divided into CT and MRI (FIG. 3).

The radiology section displays three MRI images of the patient's brain from March 20^{th} (FIG. 3), June 10^{th}, and June 25^{th} (FIG. 4). The radiology section also displays a CT image of the patient's brain from March 17^{th} (FIG. 3).

The histopathology section contains a hematoxylin and eosin (H&E) stain from March 20^{th} for glial cells indicating a right interior capsule lesion (FIG. 3).

The genetics section indicates that the patient has a methylated DNA pattern as recorded on March 20^{th} (FIG. 3).

The radiation section indicates that radiation is administered from April 9^{th} until May 4^{th} (FIG. 4).

The chemotherapy section indicates that Temodar™ therapy begins on March 30^{th} (FIG. 3). The Temodar™ is administered intravenously in 140 mg doses daily until April 21^{st}(FIGS. 3-4).

The steroids section indicates that Decadron™ administration begins on April 9^{th} (FIG. 4). Initially, Decadron™ is administered intravenously in 4 mg doses every six hours (FIG. 4). By June 10^{th}, the Decadron™ administration frequency is reduced to every 12 hours (FIG. 4), and by June 17^{th}, the Decadron™ administration frequency is reduced to every 24 hours (FIG. 4). On June 20^{th}, the Decadron™ administration frequency is reduced to every 48 hours (FIG. 4).

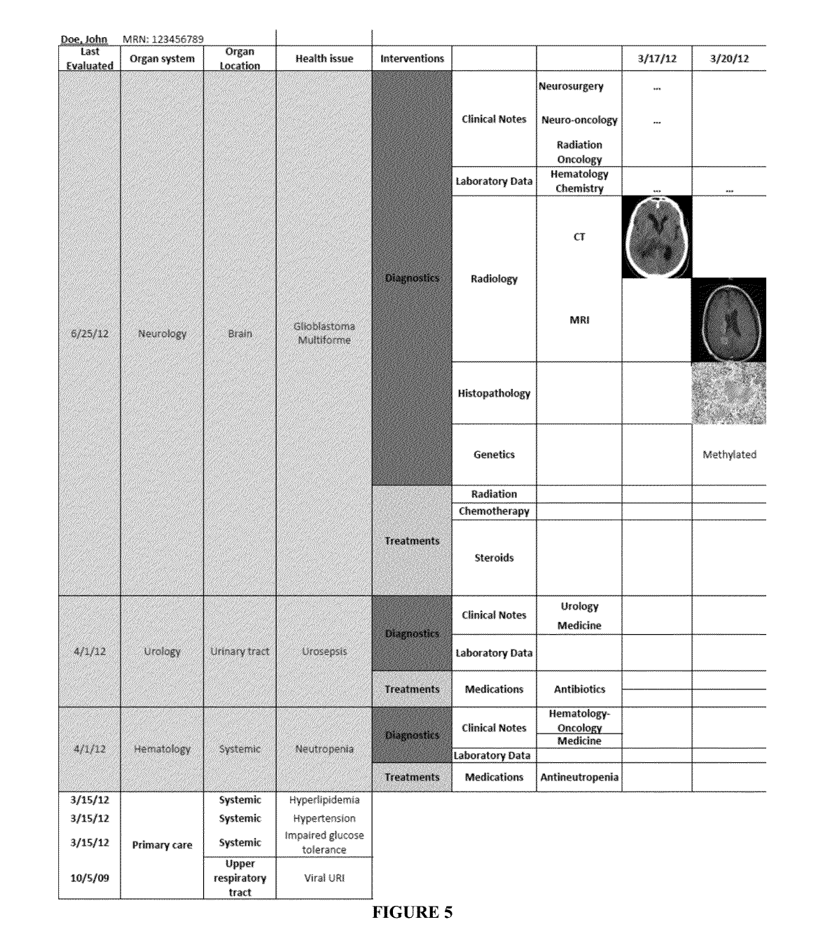

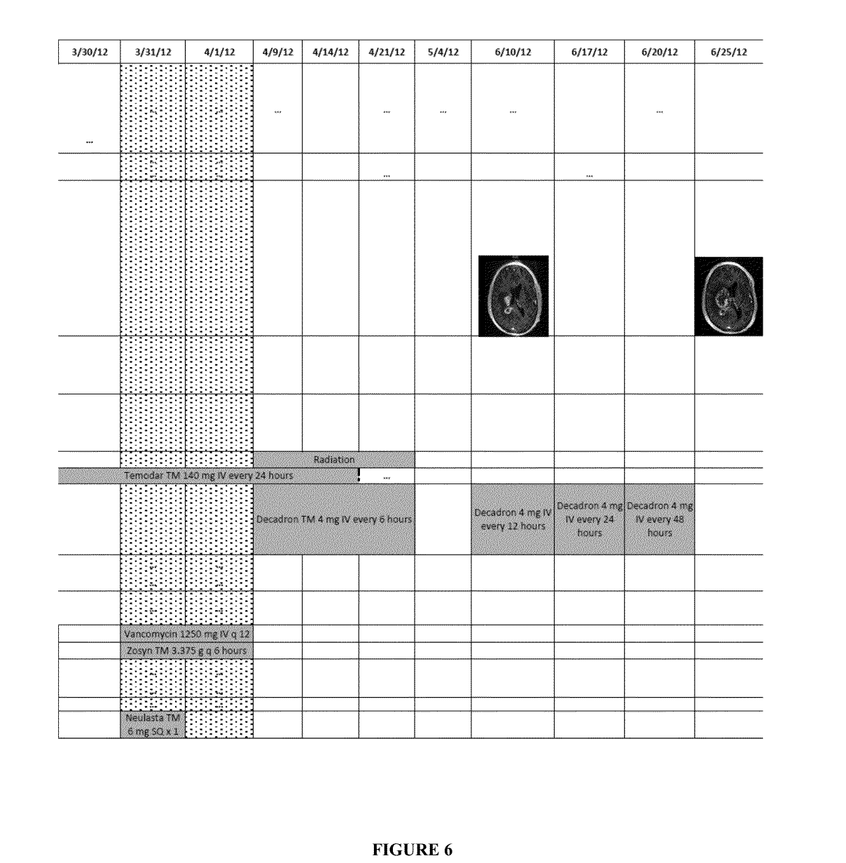

FIGS. 5 and 6 depict a full expansion of three organ systems that are involved in the patient's medical issue. The neurology section is identical to FIGS. 3 and 4.

FIG. 5 indicates that a urology evaluation is performed for the patient on Apr. 1, 2012. The urinary tract of the patient is analyzed and the patient is found to have urosepsis. The interventions section is divided into diagnostics and treatments sections (FIG. 5). The diagnostics section is further divided into clinical notes and laboratory data (FIG. 5). The clinical notes section is further divided into a urology medicine section (FIG. 5). The treatments section is divided into medications, which is further divided into an antibiotics section (FIG. 5). On Mar. 31, 2012 until Apr. 9, 2012, the patient is intravenously administered 1250 vancomycin and 3.375 grams of Zosyn™ every six hours (FIGS. 5 and 6).

FIG. 5 indicates that a systemic hematology evaluation is performed for the patient on Apr. 1, 2012. The health issue section indicates that the patient has neutropenia (FIG. 5). The diagnostics section is divided into a clinical notes and a laboratory data section (FIG. 5). The clinical notes section is further divided into a hematology-oncology and a medicine section (FIG. 5). The treatments section is divided into a medication section, which is further divided into an antineutropenia section (FIG. 5). FIG. 5 indicated that the patient is subcutaneously administered 6 mg of Neulasta™ on Mar. 31, 2012. The bottom left of FIG. 5 depicts the unexpanded data as shown in FIG. 1.

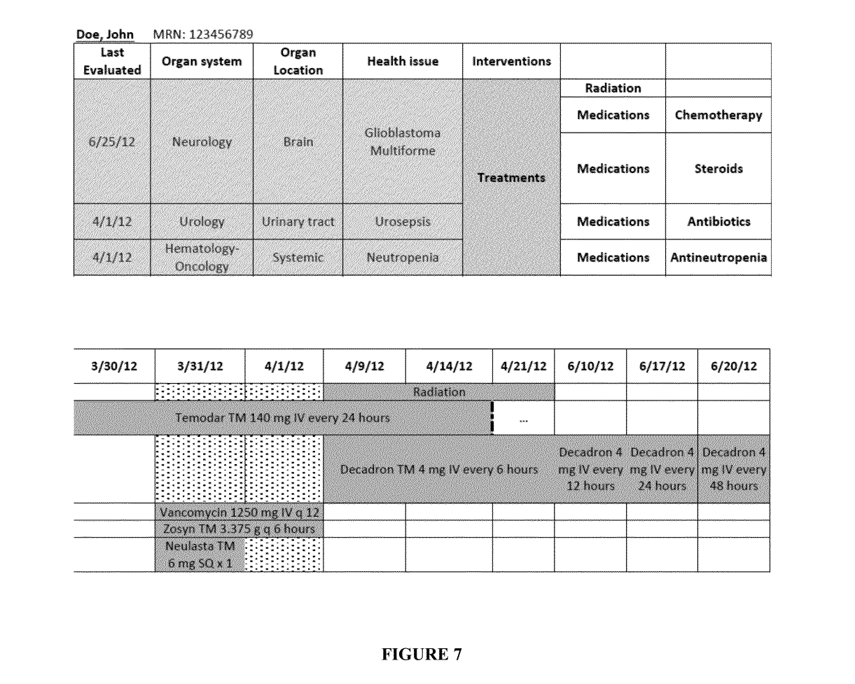

FIG. 7 depicts a display where only the treatments for each identified health issue are displayed to the user. The health issues are the same as those shown in FIGS. 1-6. For GBM, the treatments section is divided into radiation and medications. The radiation section indicates that radiation is administered from April 9^{th} until June 10^{th}. The chemotherapy section of the medications sections indicates that the patient is intravenously administered 140 mg of Temodar™ daily from March 30^{th} until April 21^{st}. The steroids section of the medications section indicates that Decadron™ administration begins on April 9^{th}. Initially, Decadron™ is administered intravenously in 4 mg doses every six hours. By June 10^{th}, the Decadron™ administration frequency is reduced to every 12 hours, and by June 17^{th}, the Decadron™ administration frequency is reduced to every 24 hours. On June 20^{th}, the Decadron™ administration frequency is reduced to every 48 hours.

Under the urosepsis section, the treatments section is divided into medications, which is further divided into an antibiotics section (FIG. 7). On March 31^{st} until April 9^{th}, the patient is intravenously administered 1250 mg vancomycin every 12 hours and 3.375 grams of Zosyn™ every six hours (FIG. 7).

Under the neutropenia section, the treatments section is divided into medications, which is further divided into an antineutropenia section (FIG. 7). FIG. 7 indicates that the patient was subcutaneously administered 6 mg of Neulasta™ on March 31^{st}.

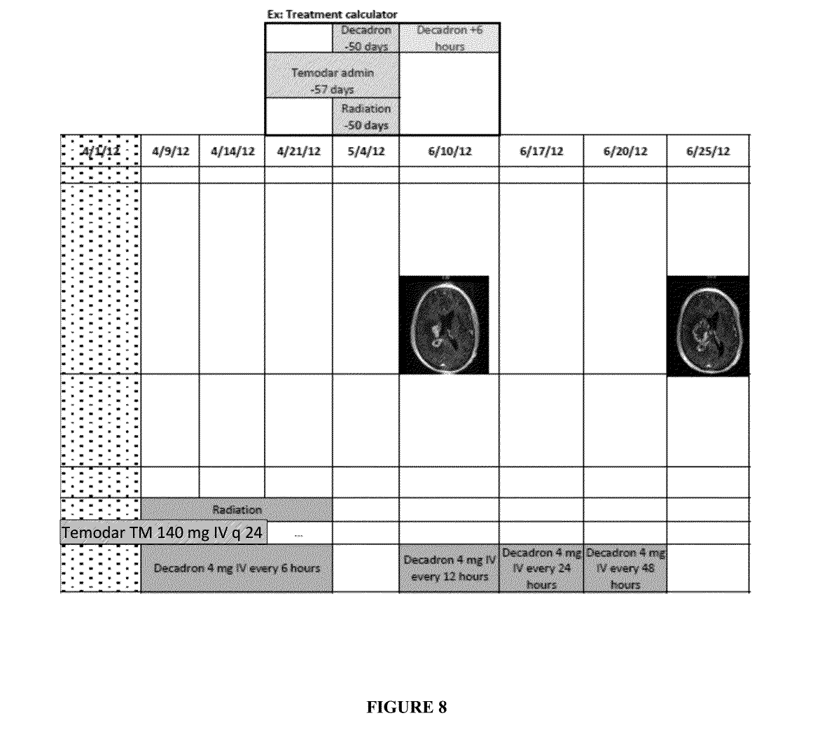

FIG. 8 depicts an example of a treatment calculator. The health issue and treatment information details are the same as those in FIGS. 3 and 4. FIG. 8 indicates that on June 10^{th}, 57 days have elapsed since the last Temodar™ treatment, 50 days have elapsed since the last radiation treatment, and 50 days have elapsed since Decadron™ was administered. Additionally, FIG. 8 indicates that the MRI imaged obtained on June 10^{th} is taken six hours after treatment with Decadron™.

### Example 2

### Computer Architectures

Another aspect of the disclosure provides a system that is programmed or otherwise configured to implement the methods of the disclosure. The system can include a computer server that is operatively coupled to an electronic device of a user, for example, a healthcare provider.

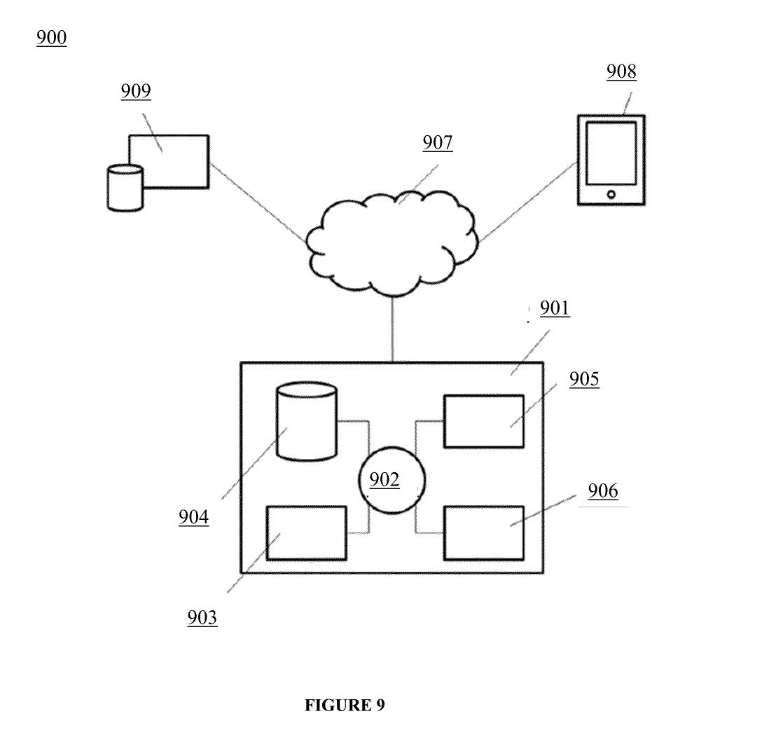

FIG. 9 shows a computer system 900 programmed or otherwise configured to allow, for example, a user to determine the health status of a subject. The system 900 includes a computer server (“server”) 901 that is programmed to implement methods disclosed herein. The server 901 includes a central processing unit 902, which can be a single core or multi core processor, or a plurality of processors for parallel processing. The server 901 also includes: memory 903, such as random-access memory, read-only memory, and flash memory; electronic storage unit 904, such as a hard disk; communication interface 905, such as a network adapter, for communicating with one or more other systems; and peripheral devices 906, such as cache, other memory, data storage and electronic display adapters. The memory 903, storage unit 904, interface 905 and peripheral devices 906 are in communication with the CPU 902 through a communication bus, such as a motherboard. The storage unit 904 can be a data storage unit or data repository for storing data. The server 901 can be operatively coupled to a computer network 907 with the aid of the communication interface 905. The network 907 can be the Internet, an internet or extranet, or an intranet or extranet that is in communication with the Internet. The network 907 in some cases is a telecommunications network or data network. The network 907 can include one or more computer servers, which can allow distributed computing, such as cloud computing. The network 907, in some cases with the aid of the server 901, can implement a peer-to-peer network, which can allow devices coupled to the server 901 to behave as a client or an independent server.

The storage unit 904 can store files, such as drivers, libraries, saved programs, and clinical data related to a subject. The storage unit 904 can store clinical data from, for example, EMRs and EHRs. The storage unit 904 can store subject data, such as biometric data, physiological readings, vital signs, body weight, and treatments at various points of a subject's medical history. The server 901 in some cases can include one or more additional data storage units that are external to the server 901, such as located on a remote server that is in communication with the server 901 through an intranet or the Internet.

The server 901 can communicate with one or more remote computer systems through the network 907. In some embodiments, the server 901 is in communication with a first computer system 908 and a second computer system 909 that are located remotely with respect to the server 901. The first computer system 908 can be the computer system of a user, and the second computer system 909 can be an external data repository. The first computer system 908 and second computer system 909 can be, for example, personal computers, such as a portable PC; slate and tablet PC, such as Apple® iPad and Samsung® Galaxy Tab; telephones; smartphones, such as Apple® iPhone, Android-enabled device, Windows® Phone, and Blackberry®; smart watches, such as Apple® Watch; smart glasses, such as Google® Glass; or personal digital assistants. The user can access the server 901 via the network 907 to view a display of the invention.

In some situations, the system 900 includes a single server 901. In other situations, the system 900 includes multiple servers in communication with one another through an intranet or the Internet. The server 901 can be adapted to store user profile information, such as, for example, a name, physical address, email address, telephone number, instant messaging (IM) handle, educational information, work information, social likes or dislikes and historical information, and other information of potential relevance to the user or subject. Such profile information can be stored on the storage unit 904 of the server 901.

Methods as described herein can be implemented by way of a machine- or computer-executable code or software stored on an electronic storage location of the server 901, such as, for example, on the memory 903 or electronic storage unit 904. During use, the code can be executed by the processor 902. In some cases, the code can be retrieved from the storage unit 904 and stored on the memory 903 for ready access by the processor 902. In some situations, the electronic storage unit 904 can be precluded, and machine-executable instructions are stored on memory 903. Alternatively, the code can be executed on the second computer system 909. The code can be pre-compiled and configured for use with a processor adapted to execute the code, or can be compiled during runtime. The code can be supplied in a programming language that can be selected to allow the code to execute in a precompiled or as-compiled fashion.

All or portions of the software can at times be communicated through the Internet or various other telecommunications networks. Such communications can support loading of the software from one computer or processor into another, for example, from a management server or host computer into the computer platform of an application server. Another type of media that can bear the software elements includes optical, electrical, and electromagnetic waves, such as those used across physical interfaces between local devices, through wired and optical landline networks and over various air-links. The physical elements that carry such waves, such as wired or wireless links, or optical links, also can be considered as media bearing the software.

A machine-readable medium, incorporating computer-executable code, can take many forms, including a tangible storage medium, a carrier wave medium, and physical transmission medium. Non-limiting examples of non-volatile storage media include optical disks and magnetic disks, such as any of the storage devices in any computer, such as can be used to implement the databases of FIG. 9. Volatile storage media include dynamic memory, such as a main memory of such a computer platform. Tangible transmission media include coaxial cables, copper wire and fiber optics, including wires that comprise a bus within a computer system. Carrier-wave transmission media can take the form of electric or electromagnetic signals, or acoustic or light waves such as those generated during radio frequency (RF) and infrared (IR) data communications.

Common forms of computer-readable media include: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, and any other medium from which a computer can read programming code or data. Many of these forms of computer readable media can be involved in carrying one or more sequences of one or more instructions to a processor for execution.

The server 901 can be configured for: data mining; extract, transform and load (ETL); or spidering operations, including Web Spidering where the system retrieves data from remote systems over a network and access an Application Programming Interface or parses the resulting markup, which can permit the system to load information from a raw data source or mined data into a data warehouse. The data warehouse can be configured for use with a business intelligence system, such as Microstrategy® and Business Objects®. The system can include a data mining module adapted to search for media items in various source locations, such as email accounts and various network sources, such as social networking accounts, such as Facebook®, Foursquare®, Google+®, and Linkedin®, or on publisher sites, such as weblogs.

Computer software can include computer programs, such as, for example executable files, libraries, and scripts. Software can include defined instructions that upon execution instruct computer hardware, for example, an electronic display to perform various tasks, such as display graphical elements on an electronic display. Software can be stored in computer memory.

Software can include machine-executable code. Machine-executable code can include machine language instructions specific to an individual computer processor, such as a CUP. Machine language can include groups of binary values signifying processor instructions that change the state of an electronic device, for example, a computer, from its preceding state. For example, an instruction can change the value stored in a particular storage location inside the computer. An instruction may also cause an output to be presented to a user, such as graphical elements to appear on an electronic display of a computer system. The processor can carry out the instructions in the order they are provided.

Software comprising one or more lines of code and their output(s) can be presented to a user on a user interface (UI) of an electronic device of the user. Non-limiting examples of UIs include a graphical subject interface (GUI) and web-based subject interface. A GUI can allow a subject to access a display of the invention. The UI, such as GUI, can be provided on a display of an electronic device of the subject. The display can be a capacitive or resistive touch display, or a head-mountable display, such as a Google® Glass. Such displays can be used with other systems and methods of the disclosure.

Methods of the disclosure can be facilitated with the aid of applications, or apps, which can be installed on an electronic device of the subject. An app can include a GUI on a display of the electronic device of the subject. The app can be programmed or otherwise configured to perform various functions of the system. GUIs of apps can display on an electronic device of the subject. Non-limiting examples of electronic devices include computers, televisions, smartphones, tablets, and smart watches. The electronic device can include, for example, a passive screen, a capacitive touch screen, or a resistive touch screen. The electronic device can include a network interface and a browser that allows the subject to access various sites or locations, such as web sites, on an intranet or the Internet. The app is configured to allow the mobile device to communicate with a server, such as the server 901.

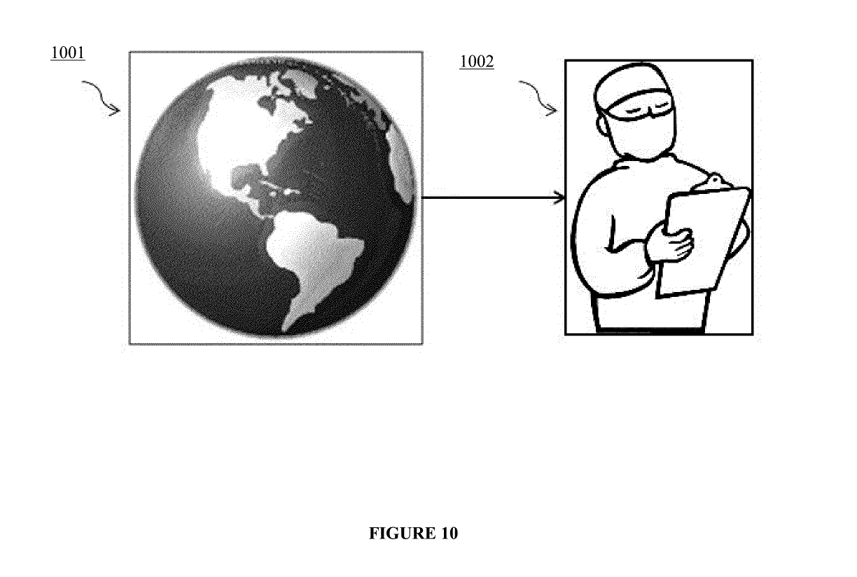

Any embodiment of the invention described herein can be, for example, produced and transmitted by a user within the same geographical location. A product of the invention can be, for example, produced and/or transmitted from a geographic location in one country and a user of the invention can be present in a different country. In some embodiments, the data accessed by a system of the invention is a computer program product that can be transmitted from one of a plurality of geographic locations 1001 to a user 1002 (FIG. 10). Data generated by a computer program product of the invention can be transmitted back and forth among a plurality of geographic locations, for example, by a network, a secure network, an insecure network, an internet, or an intranet. In some embodiments, a system herein is encoded on a physical and tangible product.

### EMBODIMENTS

### Embodiment 1

A method comprising: a) receiving into a memory sector from a first data source a first electronic communication in a computer-readable code, wherein the first electronic communication contains a first time-stamped clinical event of a first subject; b) receiving into the memory sector from a second data source a second electronic communication in a computer-readable code, wherein the second electronic communication contains a second time-stamped clinical event of the first subject; c) reading by a computer processor the computer-readable code from the first electronic communication to identify the first time-stamped clinical event of the first subject; d) reading by the computer processor the computer-readable code from the second electronic communication to identify the second time-stamped clinical event of the first subject; e) generating by an image processor a first image based on the identity of the first time-stamped clinical event of the first subject; f) generating by the image processor a second image based on the identity of the second time-stamped clinical event of the first subject; and g) displaying on a visual display the first image and the second image, wherein the visual display organizes the first image and the second image in a first dimension based on medical service type and in a second dimension based on time stamp.

### Embodiment 2

The method of embodiment 1, wherein the visual display displays the plurality of clinical events in a chronological view.

### Embodiment 3

The method of any one of embodiments 1-2, wherein the first dimension is organized by medical subspecialties.

### Embodiment 4

The method of any one of embodiments 1-3, wherein the first image is a radiological image.

### Embodiment 5

The method of any one of embodiments 1-3, wherein the first image is a photographic image.

### Embodiment 6

The method of any one of embodiments 1-5, wherein the first time-stamped clinical event is a report of laboratory data.

### Embodiment 7

The method of any one of embodiments 1-6, further comprising automatically updating the visual display with additional images in real time based on receipt into the memory sector of additional electronic communications, each of which independently contains an additional time-stamped clinical event of the subject.

### Embodiment 8

The method of any one of embodiments 1-7, further comprising marking by the image processor the first image based on access of the first image by a user, thereby indicating to a viewer that the user has accessed the first image.

### Embodiment 9

The method of any one of embodiments 1-8, further comprising: h) receiving into the memory sector from the first data source a third electronic communication in a computer-readable code, wherein the third electronic communication contains a third time-stamped clinical event of a second subject, wherein the third time-stamped clinical event corresponds to the first time-stamped clinical event of the first subject; i) receiving into the memory sector from the second data source a fourth electronic communication in a computer-readable code, wherein the fourth electronic communication contains a fourth time-stamped clinical event of the second subject, wherein the fourth time-stamped clinical event corresponds to the second time-stamped clinical event of the first subject, wherein each of the fourth time-stamped clinical event and the second time-stamped clinical event is a treatment outcome; j) reading by the computer processor the computer-readable code from the third electronic communication to identify the time-stamped clinical event of the second subject; k) reading by the computer processor the computer-readable code from the fourth electronic communication to identify the fourth time-stamped clinical event of the second subject; l) generating by the image processor a third image based on the identity of the third time-stamped clinical event of the second subject; m) generating by the image processor a fourth image based on the identity of the fourth time-stamped clinical event of the second subject; n) displaying on the visual display the third image; o) displaying on the visual display the fourth image; and p) determining a comparative degree of improvement between the clinical outcomes of the first subject and the second subject based on the second time-stamped clinical event of the first subject and the fourth time-stamped clinical event of the second subject.

### Embodiment 10

A computer program product comprising a computer-readable medium having computer-executable code encoded therein, the computer-executable code adapted to be executed to implement a method comprising: a) providing a healthcare management system, wherein the healthcare management system comprises: i) a data receiving module; ii) an identification module; iii) an image generation module; and iv) an output module; b) receiving by the data receiving module a first electronic communication in a computer-readable code, wherein the first electronic communication contains a first time-stamped clinical event for a subject from a first data source; c) receiving by the data receiving module a second electronic communication in a computer-readable code, wherein the second electronic communication contains a second time-stamped clinical event for the subject from a second data source; d) identifying by the identification module the first time-stamped clinical event of the subject by reading the computer-readable code of the first electronic communication; e) identifying by the identification module the second time-stamped clinical event of the subject by reading the computer-readable code of the second electronic communication; f) generating by the image processing module a first image based on the identity of the first time-stamped clinical event of the subject; g) generating by the image processing module a second image based on the identity of the second time-stamped clinical event of the subject; and h) outputting by the output module a visual display of the first image and the second image, wherein the output module organizes the visual display so that the first image and the second image are displayed in a first dimension based on medical service type and in a second dimension based on time stamp.

### Embodiment 11

The computer program product of embodiment 10, wherein the output module displays the plurality of clinical events in a chronological view.

### Embodiment 12

The computer program product of any one of embodiments 10-11, wherein the output module organizes the first dimension by medical subspecialties.

### Embodiment 13

The computer program product of any one of embodiments 10-12, wherein the healthcare management system further comprises an update module, wherein the update module prompts the output module to update the visual display in real time based on receipt into the data receiving module of additional electronic communications, each of which independently contains an additional time-stamped clinical event of the subject.

### Embodiment 14

The computer program product of any one of embodiments 10-13, wherein the healthcare management system further comprises a marking module, wherein the marking module marks the first image based on access of the first image by a user, thereby indicating to a viewer that the user has accessed the first image.

What is claimed is:

1. A method comprising:
a) receiving into a memory sector from a first data source a first electronic communication in a computer-readable code, wherein the first electronic communication contains a first time-stamped clinical event of a first subject;
b) receiving into the memory sector from a second data source a second electronic communication in a computer-readable code, wherein the second electronic communication contains a second time-stamped clinical event of the first subject;
c) reading by a computer processor the computer-readable code from the first electronic communication to identify the first time-stamped clinical event of the first subject;
d) reading by the computer processor the computer-readable code from the second electronic communication to identify the second time-stamped clinical event of the first subject;
e) generating by an image processor a first image based on the identity of the first time-stamped clinical event of the first subject;
f) generating by the image processor a second image based on the identity of the second time-stamped clinical event of the first subject; and
g) displaying on a visual display the first image and the second image, wherein the visual display organizes the first image and the second image in a first dimension based on medical service type and in a second dimension based on time stamp.

2. The method of claim 1, wherein the visual display displays the plurality of clinical events in a chronological view.

3. The method of claim 1, wherein the first dimension is organized by medical subspecialties.

4. The method of claim 1, wherein the first image is a radiological image.

5. The method of claim 1, wherein the first image is a photographic image.

6. The method of claim 1, wherein the first time-stamped clinical event is a report of laboratory data.

7. The method of claim 1, further comprising automatically updating the visual display with additional images in real time based on receipt into the memory sector of additional electronic communications, each of which independently contains an additional time-stamped clinical event of the subject.

8. The method of claim 1, further comprising marking by the image processor the first image based on access of the first image by a user, thereby indicating to a viewer that the user has accessed the first image.

9. The method of claim 1, further comprising:
h) receiving into the memory sector from the first data source a third electronic communication in a computer-readable code, wherein the third electronic communication contains a third time-stamped clinical event of a second subject, wherein the third time-stamped clinical event corresponds to the first time-stamped clinical event of the first subject;
i) receiving into the memory sector from the second data source a fourth electronic communication in a computer-readable code, wherein the fourth electronic communication contains a fourth time-stamped clinical event of the second subject, wherein the fourth time-stamped clinical event corresponds to the second time-stamped clinical event of the first subject, wherein each of the fourth time-stamped clinical event and the second time-stamped clinical event is a treatment outcome;
j) reading by the computer processor the computer-readable code from the third electronic communication to identify the time-stamped clinical event of the second subject;
k) reading by the computer processor the computer-readable code from the fourth electronic communication to identify the fourth time-stamped clinical event of the second subject;
l) generating by the image processor a third image based on the identity of the third time-stamped clinical event of the second subject;
m) generating by the image processor a fourth image based on the identity of the fourth time-stamped clinical event of the second subject;
n) displaying on the visual display the third image;
o) displaying on the visual display the fourth image; and
p) determining a comparative degree of improvement between the clinical outcomes of the first subject and the second subject based on the second time-stamped clinical event of the first subject and the fourth time-stamped clinical event of the second subject.

10. A computer program product comprising a computer-readable medium having computer-executable code encoded therein, the computer-executable code adapted to be executed to implement a method comprising:
a) providing a healthcare management system, wherein the healthcare management system comprises:
i) a data receiving module;
ii) an identification module;
iii) an image generation module; and
iv) an output module;
b) receiving by the data receiving module a first electronic communication in a computer-readable code, wherein the first electronic communication contains a first time-stamped clinical event for a subject from a first data source;
c) receiving by the data receiving module a second electronic communication in a computer-readable code, wherein the second electronic communication contains a second time-stamped clinical event for the subject from a second data source;
d) identifying by the identification module the first time-stamped clinical event of the subject by reading the computer-readable code of the first electronic communication;
e) identifying by the identification module the second time-stamped clinical event of the subject by reading the computer-readable code of the second electronic communication;
f) generating by the image processing module a first image based on the identity of the first time-stamped clinical event of the subject;
g) generating by the image processing module a second image based on the identity of the second time-stamped clinical event of the subject; and
h) outputting by the output module a visual display of the first image and the second image, wherein the output module organizes the visual display so that the first image and the second image are displayed in a first dimension based on medical service type and in a second dimension based on time stamp.

11. The computer program product of claim 10, wherein the output module displays the plurality of clinical events in a chronological view.

12. The computer program product of claim 10, wherein the output module organizes the first dimension by medical subspecialties.

13. The computer program product of claim 10, wherein the healthcare management system further comprises an update module, wherein the update module prompts the output module to update the visual display in real time based on receipt into the data receiving module of additional electronic communications, each of which independently contains an additional time-stamped clinical event of the subject.

14. The computer program product of claim 10, wherein the healthcare management system further comprises a marking module, wherein the marking module marks the first image based on access of the first image by a user, thereby indicating to a viewer that the user has accessed the first image.
